(19) United States
(12) Patent Application Publication
(10) Pub. No.: US 2003/0096121 A1
(43) Pub. Date: May 22, 2003

(54) Magnetically receptive ramekin

(76) Inventor: James Michael Marvin, Antioch, CA (US)

Correspondence Address: James M. Marvin, 3212 Garrow Drive, Antioch, CA, 94509, US

(21) Appl. No.: 09/988,500

(22) Filed: Nov. 20, 2001

(51) Int. Cl. B32B 15/00

(52) U.S. Cl. 428/432

(57) ABSTRACT

The Magnetically Receptive Ramekin will be for the use of any food service establishment to prevent the loss of ramekins due to accidental discarding. No ramekin available today has this benefit to offer.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The Magnetically Receptive Ramekin pertains to the food service industry.

### BREIF SUMMARY OF THE INVENTION

The Magnetically Receptive Ramekin will be attracted to magnetic trash container chutes to prevent the ramekin from being discarded.

### BREIF DESCRIPTION OF THE SEVERAL VIEWS OR THE DRAWING

FIGS. 1A, B, and C—These drawings are of the Magnetically Receptive Ramekin cut in half to show the magnetically receptive material (i.e. metal) within the basic ramekin material (i.e. porcelain).

FIG. 2—This drawing is of the Magnetically Receptive Ramekin cut in half to show the magnetically receptive material (i.e. metal) coated with desired colored material.

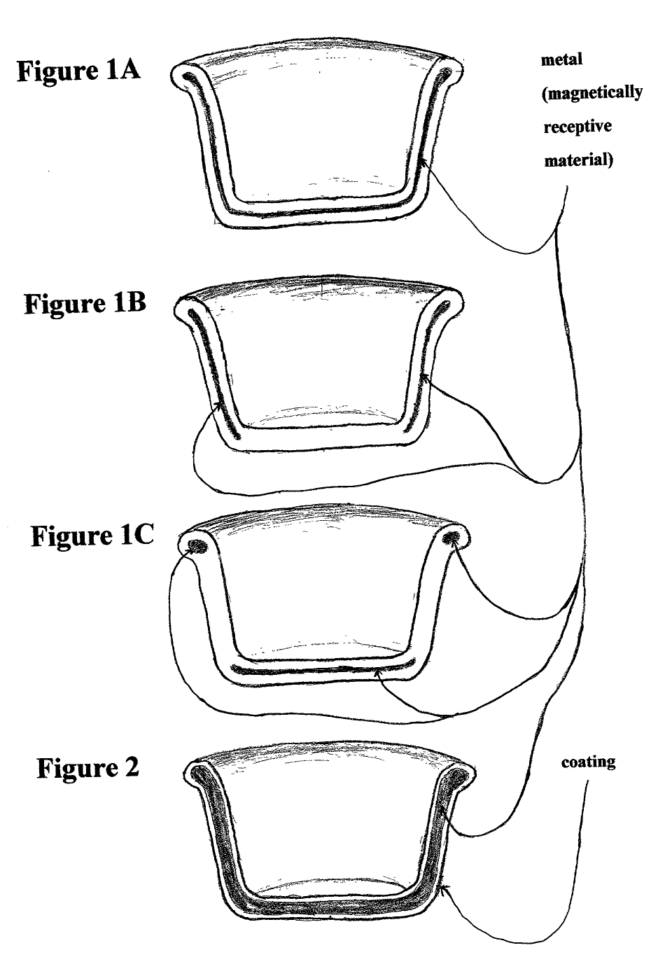

### DESCRIPTION OF THE INVENTION

The Magnetically Receptive Ramekin is any ramekin containing magnetically receptive material. The ramekin may be made of or coated with any material such as plastic, porcelain, paint, etc. as long as it contains magnetically receptive material to enable it to be attracted to magnetic trash container chutes.

1. What I claim as my invention is a ramekin that is made up of or coated with any material such as plastic, porcelain, paint, etc. as long as it contains magnetically receptive material.
What I claim as my invention is a ramekin that contains magnetically receptive material that enables it to be attracted to magnetic trash container chutes.
What I claim as my invention is a ramekin that is made up of or coated with any material such as plastic, porcelain, paint, etc. as long as it contains magnetically receptive material.
What I claim as my invention is a ramekin that contains magnetically receptive material that enables it to be attracted to magnetic trash container chutes.
